(19) United States
(12) Patent Application Publication
(10) Pub. No.: US 2023/0068351 A1
(43) Pub. Date: Mar. 2, 2023

(54) DYNAMICALLY COMPUTING PROGRESSIVE FEATURE PARAMETERS FOR SELECTABLE VOLATILITY PICK OPTIONS IN RANDOM-BASED OUTCOME GAMES

(71) Applicant: Aristocrat Technologies, Inc., Las Vegas, NV (US)

(72) Inventors: Allon Englman, Las Vegas, NV (US); Scott Delekta, Las Vegas, NV (US)

(21) Appl. No.: 17/710,441

(22) Filed: Mar. 31, 2022

Related U.S. Application Data
(60) Provisional application No. 63/236,197, filed on Aug. 23, 2021.

(51) Int. Cl. G07F 17/32

(52) U.S. Cl. CPC G07F 17/3227; G07F 17/3258; G07F 17/3213; G07F 17/34

(57) ABSTRACT

The innovations herein balance return to player (RTP) between different selectable volatility pick options (e.g., different reel set sizes) when a variable progressive feature prize (e.g., a number of free games) is awarded, while reducing loading delays and maintaining smooth operation of the gaming device. A volatility pick gateway may dynamically determine an adjustment factor for the progressive feature prize associated with a selectable volatility pick option and dynamically modify weights for a weight table associated with the selected volatility pick option. As opposed to employing lookup tables for every combination of selectable volatility pick option (e.g., reel set size) and progressive feature prize value (e.g., number of free games), one or more weights for weight tables associated with the volatility pick options may be dynamically modified. In this way, the RTP for the default volatility pick option may approximately match the RTP for the other selectable volatility pick options.

### TECHNICAL FIELD

The present application concerns electronic gaming devices, such as electronic gaming machines (“EGMs”), computers, or other mobile devices, and, in particular, a volatility pick gateway that dynamically computes one or more progressive feature parameters associated with a selectable option (such as a reel set grid size).

### BACKGROUND

Electronic gaming devices, such as EGMs, computers, or other mobile devices, provide a variety of wagering games such as slot games, video poker games, video blackjack games, roulette games, video bingo games, keno games and other types of games that are frequently offered at casinos and other locations. Play on electronic gaming devices typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the electronic gaming device and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flowchart illustrating an example technique for performing an embodiment of the disclosed technology.

FIGS. 5-7 are example screenshots and diagrams showing aspects of the disclosed technology.

### DETAILED DESCRIPTION

### I. Introduction

### I.A. Overview

The disclosed technology is directed to several features of electronic gaming devices. For example, one feature involves a volatility pick gateway that dynamically calculates one or more progressive feature parameters associated with a selectable option (such as a reel set grid size). In some embodiments, the volatility pick gateway may specifically comprise a free game gateway, wherein a user is allowed to choose his/her grid size, and the free game gateway dynamically adjusts the number of free spins (also called free games) and the extra free spin rate (also called extra free game rate) according to the selected grid/reel set size. The free game gateway could generate a large number of free games (e.g., over 10,000 free games) for a default reel size (e.g., a 3×5 grid). However, when a user chooses a different size of grid (e.g., 4×5, 5×5, 6×5, 8×5, etc.), this can, without proper balancing, change the potential payout, which in turn may affect RTP. Although this disclosure generally refers to the award of free games as an exemplary type of progressive feature for which parameters may be modified based on a selectable option (such as grid size), it is to be understood that other types of progressive features or prizes could also be awarded to a player, which may also need to be modified based on a particular option selected by the player, so as to achieve a designated game RTP that complies with regulations. Examples of these other types of progressive features that may be awarded to players include jackpot prizes, increased multiplier values, increasing a number of higher-paying or “wild” symbols on the reel strips, etc.

To balance RTP among the various grid sizes, the number of free games awarded and the extra free game rate can be adjusted depending on the grid size selected. Conventionally, this may be achieved through the use of predefined tables that address each combination of free games and selectable grid size, e.g., by providing a scaled number of free games and adjusted extra free game rate for each possible value for the base number of free games and each grid size. However, in a circumstance where the range of possible values for the base number of free games is quite large (e.g., from 15 free games to 10,000 or more free games), the associated gaming device or server may experience memory and loading issues, which may cause a game to perform sluggishly or even crash. For example, if the maximum number of free games is capped at 10,000 free games and the minimum number of free games is 15 free games, the gaming device/server may need to load roughly 40,000 tables when four additional grid size options are available. The time it takes for a gaming device/server to load 40,000 tables, which conventionally may be stored as XML files, causes a noticeable delay when entering the free game gateway.

The innovations can be implemented as part of a method, as part of an electronic gaming device, such as an EGM or mobile device, or on an electronic gaming server configured to perform the method, or as part of non-transitory computer-readable media storing computer-executable instructions for causing one or more processors in a computer system to perform the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### I.B. General Considerations

The detailed description presents innovations in electronic gaming machines (“EGMs”) and other electronic gaming devices. Various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense. Rather, the scope of the present disclosure is defined by the appended claims.

The innovations described herein may, among other things, balance RTP between different selectable options (such as different grid sizes, different numbers of wild symbols added to reels, different multipliers, different approaches to resolving dynamic symbols in reels, different numbers of wild reels, a combination of two or more options, etc.) when a variable number of free games (or other type of progressive feature prize) is awarded, while eliminating loading delays and maintaining smooth operation of the gaming device or associated server. To that end, the volatility pick gateway may dynamically compute the value of the progressive feature prize (e.g., in terms of a number of free games) associated with a selectable option (e.g., a non-default grid size) and dynamically modify one or more weights, so as to ensure the proper progressive feature prize value (e.g., in terms of a number of free games) is returned to the player, no matter which selectable option is selected by the player in the volatility pick gateway. For example, in a so-called “all-ways” game, as the grid size increases in size, the average feature payout would also increase. As opposed to employing lookup tables for every possible combination of grid size and value of the variable number of free games that are to awarded to the player, as one might do in a more conventional scheme, the number of free games for each grid size can be dynamically calculated and one or more weights associated with triggering additional free games may be adjusted. In this way, the average feature payout for the default grid size matches the average feature payout for an increased, or adjusted, grid size.

Generally, to determine the number of free spins to award for each selectable option, the number of initial free games for a first option (e.g., default grid size) out of multiple selectable options should be determined. In some embodiments, the initial number of free games may depend on the state of a free games meter with progressive increments that may be incremented based on a random event. For example, the number of free games may be determined based on a trigger condition, such as an award in a base game or a supplemental feature selection mechanism.

For a selected option, an adjustment factor (e.g., win factor) may be determined. The adjustment factor may represent one or more differences between the first option and the selected option (e.g., a difference in win rate). For example, a selected default grid size (e.g., 3×5) would have a win factor of 1, a selected increased grid size (e.g., 4×5) could have a win factor of 1.8, an even larger selected grid size (e.g., 5×5) could have a win factor of 3.5, etc., etc. Determining the adjustment factor may include, for example, using a lookup table associating different adjustment factors with different options of the multiple selectable options.

The number of free games for the selected option can be calculated based on the adjustment factor and the number of free games initially determined for the first option. An extra free game rate for the selected option can then be calculated and implemented dynamically to balance RTP between the selected option and the first option. In this way, the generation of lookup tables covering every possible combination of free game and extra free game awards may be circumvented, leading to improved loading times and smoother gameplay.

The number of free games for the selected option may be awarded, and that number of free games may be subject to increase with an extra free game rate mechanism that incorporates the extra free game rate for the selected option. For example, a base game may include a feature game trigger (e.g., based in part on a random event and a lookup table) that could incorporate the extra free game rate during the feature game. A lookup table could be employed to associate different numbers of extra free games with different weights and calculating the extra free game rate for a selected option could further include adjusting one or more of the different weights of the lookup table. In some embodiments, multiple lookup tables may be implemented.

As mentioned above, in other embodiments, the type of progressive feature awarded to a player may be a prize other than free games. Similarly, the value of the progressive feature award for the selected option can be calculated based on the adjustment factor and the value of the progressive feature award initially determined for a first (or default) option. As one example, if an increased multiplier value progressive feature prize for a 3×5 grid size is decided to be a multiplier factor of 5×, then, due to a higher average payout for a selected increased grid size (e.g., a 4×5 grid size), a decreased equivalent multiplier factor of, say, 2.78× may be calculated to award to the player. However, assuming that an integer multiplier value award (e.g., an even 2× multiplier) must be used in the game, an additional adjustment of one or more weights or other values used to determine one or more other awards or value given back to the player as part of the progressive feature prize (e.g., the likelihood of a wild symbol appearing on a real or a mystery jackpot being awarded to the player, etc.) may be further adjusted to ensure the RTP is approximately the same as it is for the default grid size (e.g., assuming the player is awarded a 2× multiplier prize in this example, additional value may be returned to the player that is equivalent to the “missing” 0.78 multiplier value that the player is entitled to receive as part of the progressive feature prize at the selected 4×5 grid size).

### II. Example Electronic Gaming Servers and Electronic Gaming Machines or Devices

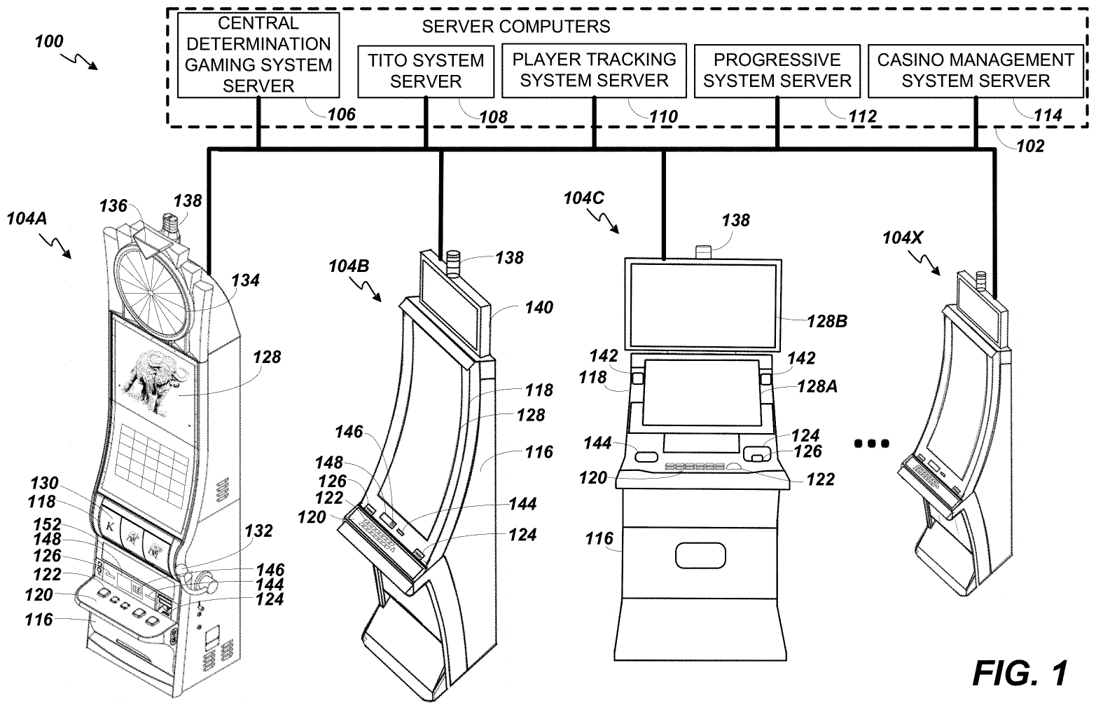

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a web site maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple electronic gaming devices connected to networks implemented with one or more of the different server computers 102 described herein.

### II.A. Example Server Computers

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

### II.B. Example Gaming Devices

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

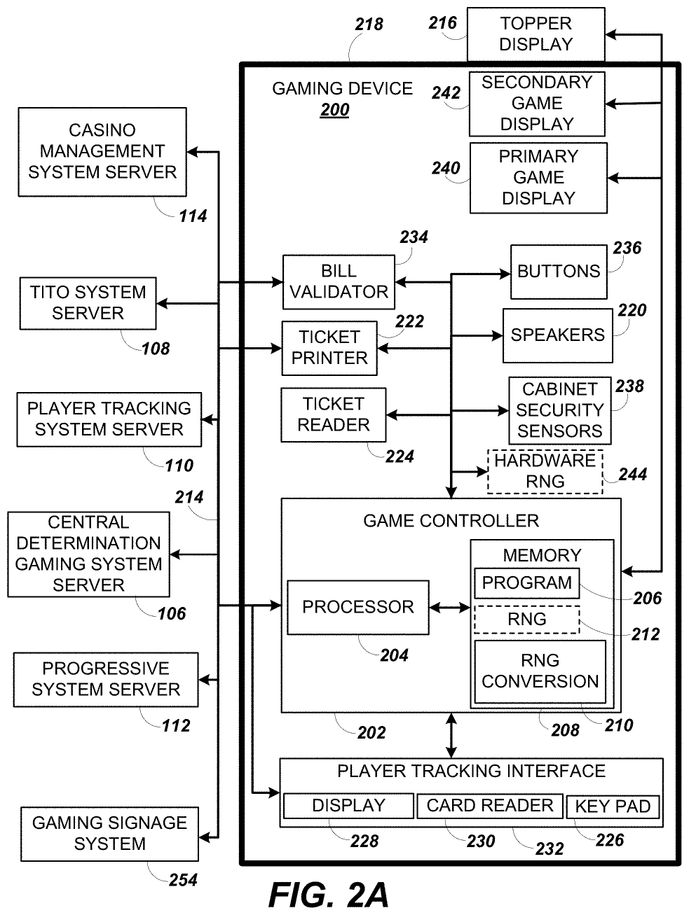

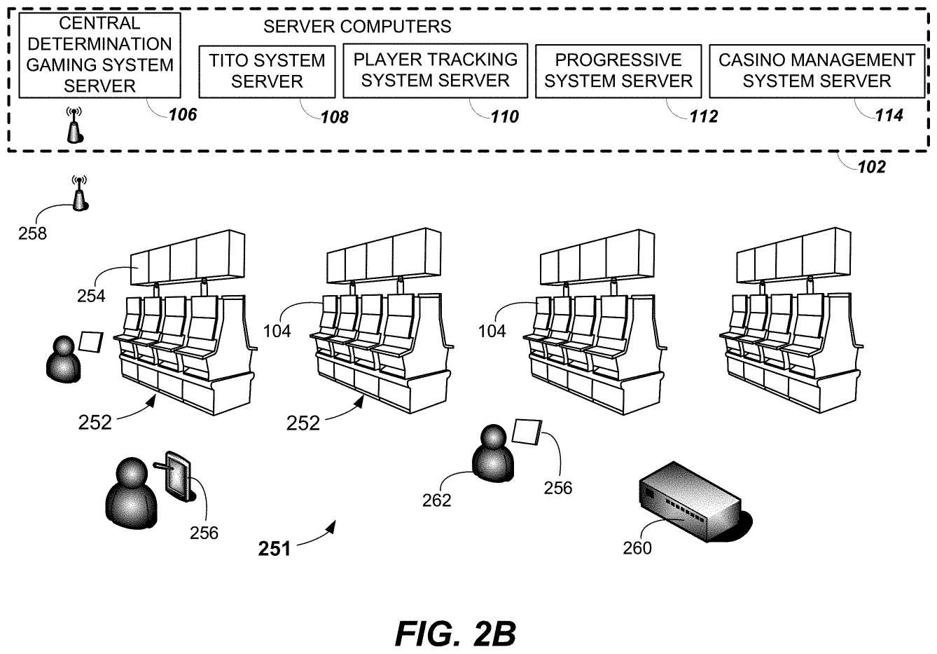

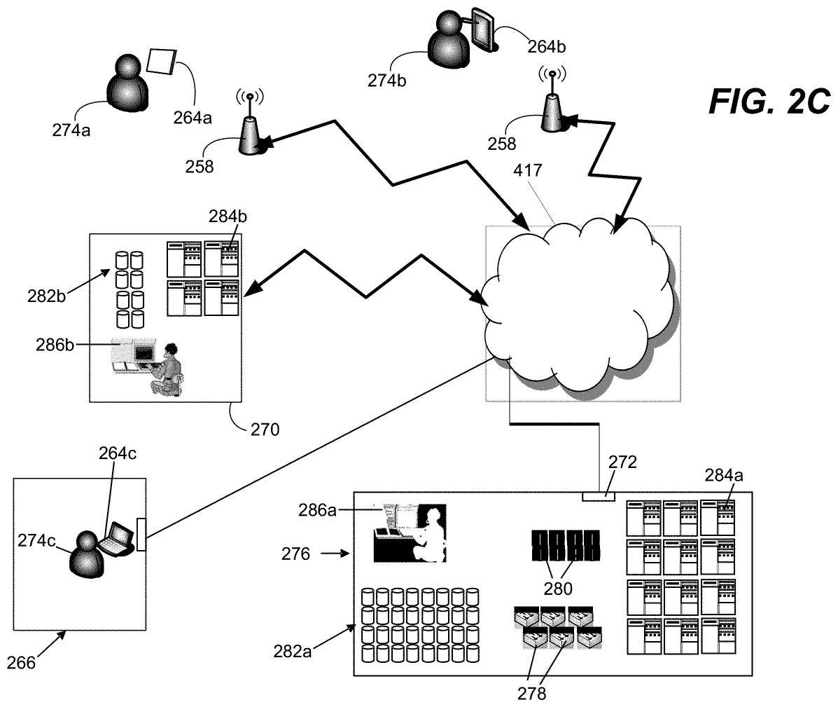

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

### II.C. Example Components of Gaming Devices

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

### II.D. Example Gaming Environment

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

### II.E. Example Distributed Gaming Delivery

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272, including and one or more workstations 286a. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

### II.F. Example Game Processing Architecture

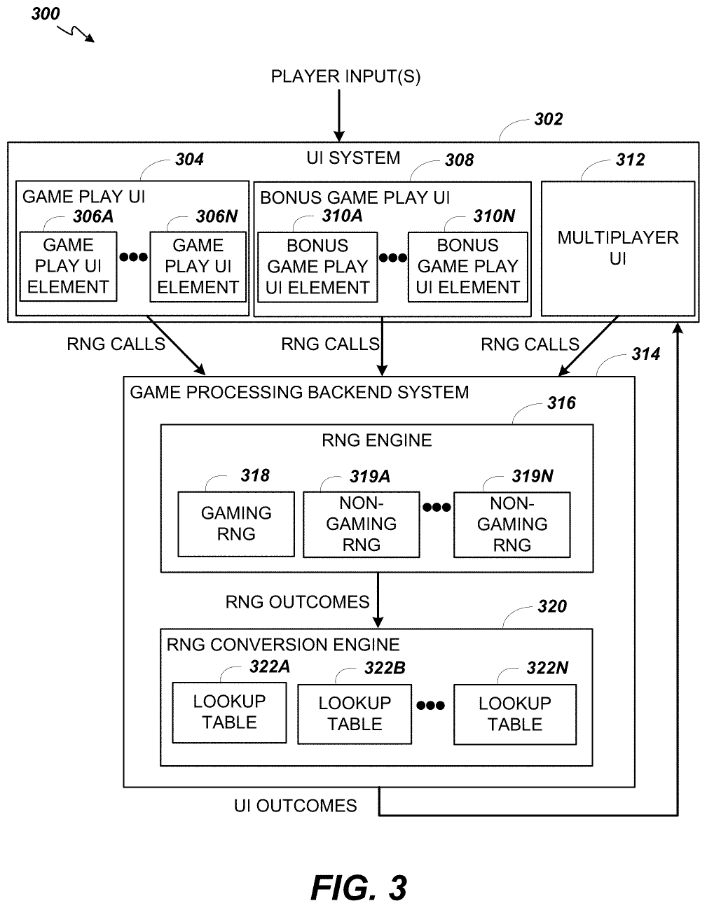

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### III. Example Embodiments

### III.A. Base Game

In embodiments, an example of a base game capable of utilizing a volatility pick gateway that computes one or more progressive feature parameters associated with a selectable option. For example, a free game volatility pick gateway may dynamically compute the number of progressive free games awarded for each selectable grid size (e.g., one of game play UI elements 306A-N), which may be displayed via the display of an electronic gaming device, such as game play UI 304. In embodiments, the base game may be controlled and displayed locally in a standalone electronic gaming device, or it may be a part of a networked configuration with one or more electronic gaming devices in communication with game processing backend system 314.

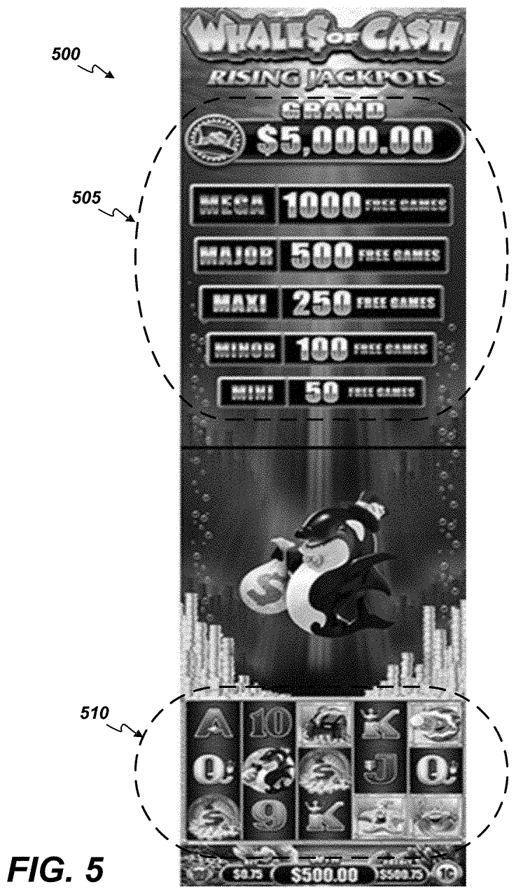

In an example embodiment, the base game may resemble screenshot 500 of FIG. 5. In this example, default grid 510 is a 3×5 grid, and five random pulls may be executed for the reel stops using a given reel set (e.g., an RNG call may be sent to RNG engine 316). As the base game progresses, the top of the screen displays a number (shown here as five) different free game progressive jackpots 505 (e.g., a free games meter), where one or more jackpots (e.g., Mega) includes a large number of free games (e.g., 1,000 free games).

### III.B. Progressive Increment Check

### a. Option 1

In order to advance through the tiers of the progressive feature prizes available for the player to win (e.g., different tiers of jackpots awarding different numbers of free games to the player, as shown in the example of FIG. 5), certain outcomes may first be achieved in the base game. For example, if a wild symbol (or, in some embodiments, any other symbol may be associated with a triggering event) lands on the game, it may trigger a determination to add value (e.g., a determined number of free games) to one (or more) of the progressive feature jackpots. In some embodiments, a threshold count of instances of target symbols (or a particular combination or one of several combinations of target symbols) must land. For example, the game may perform one random pull (e.g., send an RNG outcome to RNG conversion engine 320) into a “Progressive_Free_Game Event-#” lookup table, where # is the current bet multiplier in play. In this way, a different lookup table (e.g., lookup tables 322A-N) for each bet multiplier may be utilized, if desired.

An example for a bet multiplier of 1 being used in a game where the progressive feature prize is free games is shown below; for other bet multipliers, the lookup table may be the same, but with different weights to account for the change in bet multiplier:

<weighttable name=“Progressive_Free_Game_Event 1” type=”string>
<weightentry count=“250” value=“None”/>
<weightentery count=“30” value=“+l Free Game”/
<weightentery count=“3” value=“Boost”/>
</weighttable>

In some embodiments, the weights may be structured such that the “None” result is a most likely outcome according to weight value, the “+1 Free Game” result is a less likely outcome (a smaller weight value), and the “Boost” result is the least likely outcome (associated with the smallest weight value). The “Boost” result adds a variable number of free games.

In such an embodiment, if, for example, “+1 Free Game” is awarded, then a random pull may be performed into a “Progressive_Free_Game_Receive_Boost_Table_#” where # is the current bet multiplier. An example is shown below for a bet multiplier of 1; this may determine which jackpot (see 505 of FIG. 5) meter to add 1 free game to:

<weighttable name=“Progressive_Free_Game_Receive_Boost_Table_1” type=”string>
<weightentry count=“3” value=“MEGA”/>
<weightentery count=“10” value-“MAJOR”/
<weightentery count=“20” value=“MAXI”/>
<weightentery count=“35” value=“MINOR”/>
<weightentery count=“50” value=“MINI”/>
</weighttable>

In some embodiments, the weights may be structured such that the likelihood of a particular jackpot meter being selected increases as the expected value of the decreases. For example, the “MINI” jackpot meter (largest weight value in the table) may be a more likely outcome than the “MINOR” jackpot meter (smaller weight value), which may be more likely than the “MAXI” jackpot meter (still smaller weight value), etc.

If, however, “Boost” is selected from the “Progressive_Free_Game_Event-#” lookup table (instead of +1 Free Game), then a random pull may be performed into the “Progressive_Free_Game_Receive_Boost_Table_#” where # is again the current bet multiplier. As described in the previous paragraph, this pull may determine which one of the free game jackpot meters may receive an increment. Once the jackpot meter is determined, the number of free games to award may then be determined. This may be achieved by performing a random pull into “Boost_Table_#” where # is the current bet multiplier to get a free award of, for example, 2 to 20 games. An example is shown below:

<weighttable name=“Progressive_Free_Game_Boost_Table 1” type=”int>
<weightentry count=“350” value=“2”/>
<weightentery count=“40” value=“3”/
<weightentery count=“20” value=“4”/>
<weightentery count=“15” value=“5”/>
<weightentery count=“2” value=“20”/>
</weighttable>

In some embodiments, the weights may be structured such that the likelihood of a particular result decreases as the potential number of free games awarded increases. For example, an award of 2 games may be a more likely outcome (e.g., a weight of 350) than 3 free games (e.g., a weight of 40), which may be more likely than 4 free games (e.g., a weight of 20), etc.

Naturally, for other bet multipliers, different boost tables with different weights could be used. For example, as the bet level increases, the number of free games added to each free game award may increase. For example, when the bet multiplier is 1, the average number of free games added could be 2.7 free games. However, when the bet multiplier is 2, the average number of free games added could be 5.2 free games.

In some embodiments, the progressive increment check may be standalone to each particular electronic gaming device, or the progressive increment check may be shared among multiple users until a reset occurs at a particular electronic gaming device.

### b. Option 2

An alternative embodiment for advancing through the progressive increment check may include adding the same progressive feature prize value (e.g., in terms of a number of free games) for all bet levels. This may eliminate the need for some weighting and streamline operations.

### c. Option 3

Yet another embodiment for advancing through the progressive increment check may include first selecting/determining a particular progressive feature prize jackpot meter (e.g., MEGA, MINI, MINOR, etc.). Based on the selected jackpot meter, the game may determine the value (e.g., in terms of a number of free games) to add for the jackpot level. In some embodiments, the boost level can also be based on the bet level, much the same as with Option 1.

### III.C. Progressive Reset

In some embodiments, each progressive jackpot meter may have a reset value that is stored on a per bet multiplier basis. The table for each bet multiplier may be of the format “Progressive_Free_Game_Reset_Table #” where # is the current bet multiplier. In an alternative embodiment, the reset level may be the same for all bet levels. In some embodiments, the progressive reset may be standalone to a particular electronic gaming device, or it may be shared among several electronic gaming devices such that a reset at one electronic gaming device triggers a reset at all connected electronic gaming devices.

### III.D. Volatility Pick Gateway

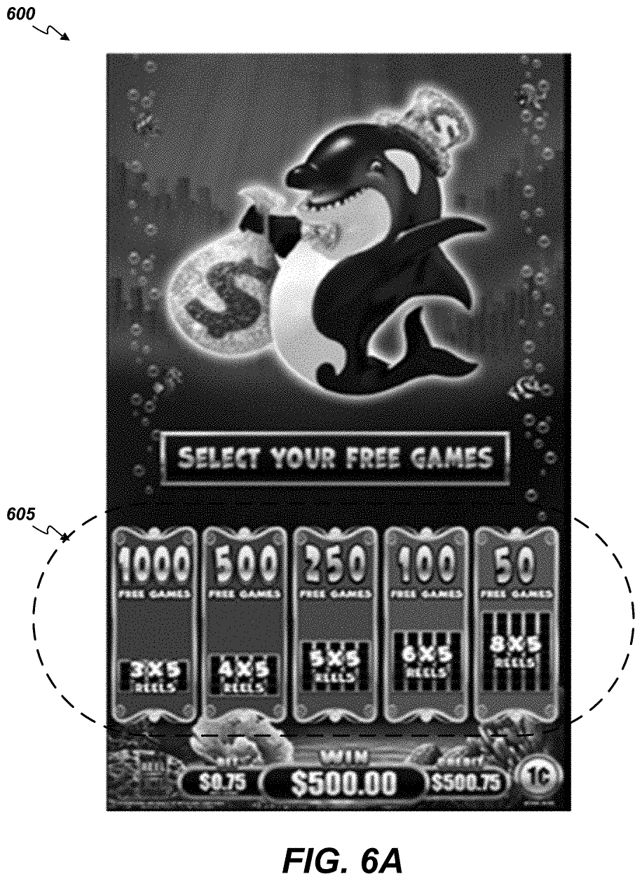

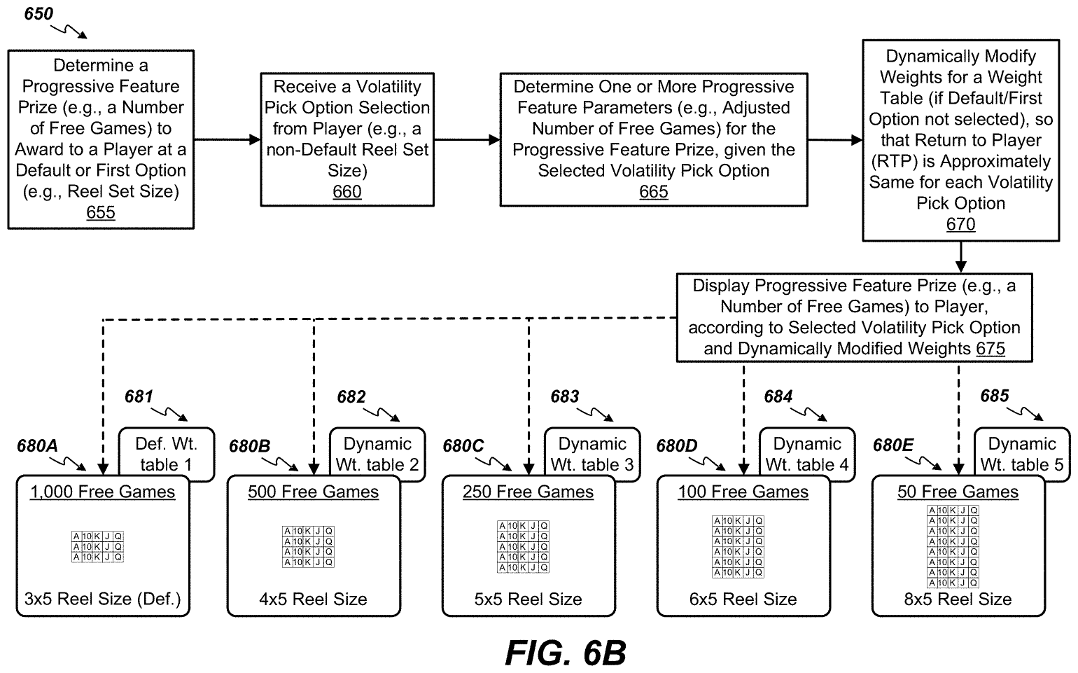

FIG. 6A shows an example screenshot of a volatility pick gateway 600, according to embodiments of the present disclosure. The volatility pick gateway 600 may correspond to bonus gameplay UI 308 that, in this example, awards additional free games to the player, and the selectable grid sizes may correspond to Bonus Game Play UI Elements 310A-N. A user, or player, may, when awarded with one or more free games, select one of a plurality of selectable grid size options 605. If the user selects the default grid size (e.g., the 3×5 grid), the free games may operate substantially similarly to the base game described herein (e.g., there would be a win factor of 1). However, if the user selects any grid size other than the default grid size, the game may use a win factor, as described herein, to dynamically determine the number of free games to award. Table 1 is an example of calculated win factors that may be stored in separate lookup tables:

TABLE 1

| Grid Size | Data-xml |
|---|---|
| 4x5 | <weighttable name=“Free_Game_Win_Factor_4x5” type=“string”> |
| | <weightentry count-“1” value=“1.95”/> |
| | </weighttable> |
| 5x5 | <weighttable name=“Free_Game_Win_Factor_5x5” type=“string”> |
| | <weightentry count-“1” value=“4.33”/> |
| | </weighttable> |
| 6x5 | <weighttable name=“Free_Game_Win_Factor_6x5” type=“string”> |
| | <weightentry count-“1” value=“7.50”/> |
| | </weighttable> |
| 8x5 | <weighttable name=“Free_Game_Win_Factor_8x5” type=“string”> |
| | <weightentry count=“1” value=“18.1”/> |
| | </weighttable> |

The number of free games that would have been awarded by a default grid size can be divided by the win factor corresponding to the user's selected grid size. For example, if 18 free games would have been won on a default grid size of 3×5, the number of free games for a user-selected 5×5 grid would be, according to Table 1: TRUNC(18/4.33) =4 free games. By adjusting the number of free games (or other types of progressive feature prizes) awarded to the player, the overall payout (e.g., free games plus other awards) may be brought into compliance with RTP regulations.

### III.E. Progressive Feature Prizes

In some embodiments, 5 random pulls may be performed for each reel set based on the current grid size selected. Table 2 shows example xml files associated with each potential grid size for a game wherein the progressive feature prize awarded to the player comprises free games:

| Grid Size | Reel Strip Data | Slot Data |
|---|---|---|
| 3x5 | free_games_3x5_reelstrips.xml | free_games_3x5_slot.xml |
| 4x5 | free_games_4x5_reelstrips.xml | free_games_4x5_slot.xml |
| 5x5 | free_games_5x5_reelstrips.xml | free_games_5x5_slot.xml |
| 6x5 | free_games_6x5_reelstrips.xml | free_games_6x5_slot.xml |
| 8x5 | free_games_8x5_reelstrips.xml | free_games_8x5_slot.xml |

In some embodiments, whenever a wild symbol substitutes in one or more winning combinations, there may be a chance to award extra fee games (e.g., up to 3). A random pull may be performed into a table of the form “ExtraFreeGames Feature_3×5”. There may be one table per grid size. For example, an example table for the initial 3×5 grid is shown below:

<weighttable name=“ExtraFree Games_Feature_3x5” type=”int>
<weightentry count=“350” value=“0”/>
<weightentery count=“40” value=“1“/
<weightentery count=“20” value=“2”/>
<weightentery count=“3” value=“3“/>
</weighttable>

In some embodiments, the weights for the default grid size may be structured such that the likelihood of a particular result decreases as the count of free games being awarded increases. For example, an award of 0 free games may be a more likely outcome (e.g., a weight of 350) than an award of 1 free game (e.g., a weight of 40), which may be more likely than an award of 2 free games (e.g., a weight of 20), etc. In some embodiments, the value of at least one weight (such as the weight associated with the entry for 3 extra free games) can vary to adjust the expected count of extra free games.

For the grid size selected by the user, the respective weight table may be dynamically modified based on the number of free games awarded. This may only need to be performed when the user selects a grid size other than the default grid size, in order to control for RTP. In some embodiments, a new value for extra free games (e.g., the up to 3 extra free games shown in the weight table above) should be calculated to rebalance for RTP.

Referring to FIG. 6B, illustrated is an example method 650 for performing an embodiment of the disclosed technology. At 655, a progressive feature prize (e.g., a number of free games) to award a player is determined at a first or default option (e.g., reel set size). For instance, in this example, the default reel set size will be 3×5, and the determined value of the progressive feature prize to award the player is 1,000 free games, although it is to be understood that this default reel size and number of free games are merely exemplary and chosen for illustrative purposes. At 660, the method may receive a volatility pick option selection from the player, such as a non-default reel set size that the player would like to use while playing the awarded free games (e.g., 3×5, 4×5, 5×5, 6×5, or 8×5). It is to be understood that choosing the height (i.e., number of rows) of the reel set size is merely one illustrative example of a variable factor that the player has a choice to control (and which may be subsequently balanced for, as will be explained in further detail at 670). Other examples of variable factors that a player may choose in a given implementation may include, e.g., adding more wild symbols to the reel sets, adding a mystery prize to the reel sets, etc.

At 665, the method may determine one or more progressive feature parameters for the progressive feature prize being awarded, based on the volatility pick option that was selected by the player. For example, in some instances, the one or more progressive feature parameters may comprise calculating how may free games to award the player based on a selected reel set size (e.g., 1,000 free games, 500 free games, 250 free games, etc.) and determining how much each spin is worth (including any re-triggers) given the option (e.g., reel set size) that was selected by the player. In other instances, the one or more progressive feature parameters may comprise one or more weights or values used by the game to control the amount of value returned to the player when they win the progressive feature prize.

As stated above, each grid size may have a pre-determined win factor. Generally, the win factor increases as the grid sizes increases (especially in the case of all-ways games). Because the win factor increases as the grid size increases, to maintain the approximately the same RTP across all selectable grid sizes, the number of free games need to decrease as the grid size increases. As an example, if the progressive feature prize is 18 free games for the 3×5 grid size, the other (i.e., larger) grid sizes may return equivalent value by awarding the player fewer than 18 free games. For example, at a 4×5 grid size, 18 free games may have the equivalent value of 4.5 free games. Because, in most embodiments, the game cannot award a player a non-integer number of free games, the game may instead award only 4 free games to the player at the selected 4×5 grid size. However, the value associated with the “missing” 0.5 free games' worth of value still needs to be returned to the player in some other fashion. In this example, the missing 0.5 free games' worth of value may be returned to the player by increasing the odds that the player is awarded extra free games while playing the already-awarded 4 free games.

It is to be understood that other games could award this missing value in other ways (e.g., by increasing a multiplier, or adding more higher-paying symbols to the reel set, etc.). Thus, at 670, one or more weights for a weight table may be dynamically modified (e.g., if the default/first option for the volatility pick is not selected by the player), such that each volatility pick has approximately the same RTP, e.g., RTPs that are each within any relevant regulatory limits. For example, in some implementations, where expected RTP of a committed wager is dependent in whole, or in part, upon a player's choice, the ratio of the expected RTP from best choice to worst choice must be less than 1.005 (or some other defined regulatory limit). At 675, the progressive feature prize interface 680 may then be displayed to the player (e.g., on the display of an electronic gaming device), according to the selected volatility pick option and the dynamically-modified weight values for the selected option.

As illustrated in FIG. 6B, at the default reel set size of 3×5, in this example, where the progressive feature prize being awarded to the player is 1,000 free games, as shown in free game interface 680A, a default or unmodified dynamic weight table 1 681 may be used by the system to determine when to award any extra free games (e.g., via the user receiving a wild symbol on a spin during the playing of the free games). At the non-default reel set size of 4×5, as shown in free game interface 680B, there may only be 500 free games awarded to the user (i.e., rather than the equivalent 1,000 free games awarded at the default reel set size of 3×5), and a modified dynamic weight table 2 682 may be used by the system to determine when to award any extra free games during the playing of the free games (i.e., to ensure that the that the RTP for the 4×5 reel size volatility pick has approximately the same RTP as the default 3×5 reel size, e.g., by returning any fractional “missing” games' worth of value to the player, as described above). Likewise, at the non-default reel set size of 5×5, as shown in free game interface 680C, there may only be 250 free games awarded to the user, and a modified dynamic weight table 3 683 may be used by the system to determine when to award any extra free games during the playing of the free games. Similarly, at the non-default reel set size of 6×5, as shown in free game interface 680D, there may only be 100 free games awarded to the user, and a modified dynamic weight table 4 684 may be used by the system to determine when to award any extra free games during the playing of the free games. Finally, at the non-default reel set size of 8×5, as shown in free game interface 680E, there may only be 50 free games awarded to the user, and a modified dynamic weight table 5 685 may be used by the system to determine when to award any extra free games during the playing of the free games.

As may now be understood, by dynamically modifying the weight tables at 670, the method 650 may be able to handle a wide range of values of progressive feature prizes being awarded to the player (e.g., although this example discussed a progressive feature prize of 1,000 free games being awarded to the player, the number of free games awarded by a given gaming device could range, e.g., from anywhere to 5 free games to 10,000 free games—or even many more free games, in the event that there is a wide-area jackpot linked to multiple gaming machines). Such a wide range of values for progressive feature prizes that could be awarded to a player would require large amounts of storage space and processing power if the weighting tables were precalculated and stored on the gaming device in advance of play. Thus, as explained above, for each non-default reel set size that may be selected by the user, the respective weight table may be dynamically modified based on a determined adjusted value (e.g., in terms of a fractional number of free games) that needs to be awarded to the player at the selected reel set size, and this operation may only need to be performed once (i.e., whenever the player selects a reel set size other than the default grid size), in order to properly control for RTP.

### a. Example Calculations

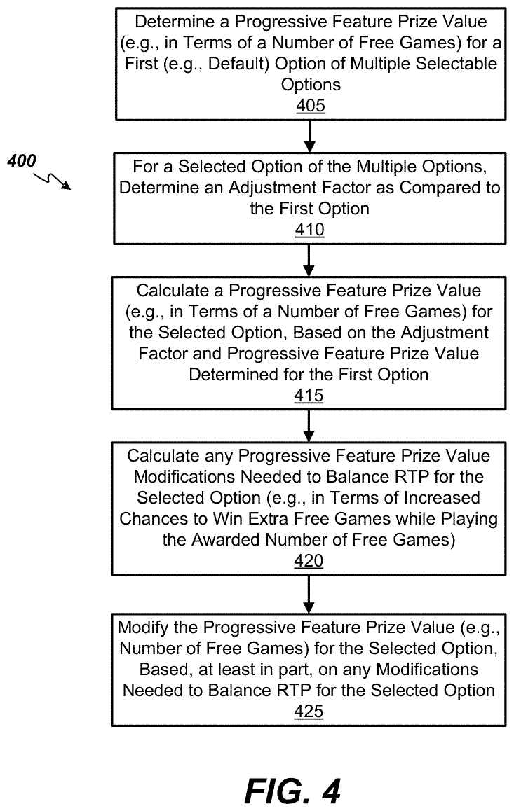

Referring back now to FIG. 4, illustrated is another example method 400 for performing an embodiment of the disclosed technology. At 405, a progressive feature prize award method 400 determines a progressive feature prize value for a first option (e.g., default option) of multiple selectable options. For example, the award type for the progressive feature prize award method could be a number of free games to award the player for a default option. As described herein, the initial number of free games may depend on the state of a free games meter with progressive increments that may be incremented based on a random event. For example, the number of free games may be determined based on a trigger condition, such as an award in a base game or a supplemental feature selection mechanism.

At 410, an adjustment factor is determined for a selected option of the multiple options, the adjustment factor representing one or more differences between the selected option and the default option. In some embodiment, the adjustment factor may be precalculated for each selectable option, or it may be calculated for a particular option in response to a user selecting that option. Determining the adjustment factor may include, for example, using a lookup table associating different adjustment factors with different options of the multiple selectable options.

At 415, the progressive feature prize value (e.g., in terms of a number of free games) may be calculated for the selected option, based on the adjustment factor determined at 410 and the progressive feature prize value (again, e.g., in terms of a number of free games to award the player) that was determined at 405 for the first (e.g., default) option.

At 420, any progressive feature prize value modifications that are needed for the selected option may be calculated. For example, in the case of a progressive feature prize that is awarded in terms of free games, an extra free game rate for the selected option may be calculated and implemented (e.g., in terms of increased chances to win extra free games while playing the awarded number of free games) to balance RTP between the selected option and the first (e.g., default) option. As will be described in greater detail below, in some embodiments, these modifications may be implemented via the dynamic modification of weights for a weight table of random-based game outcomes associated with the selected option. In this way, the offline generation and storage of lookup tables covering every possible combination of free game and extra free game awards for every selectable option may be circumvented, leading to improved loading times and smoother gameplay.

At 425, the progressive feature prize value (e.g., a determined number of free games) for the selected option may be modified based, at least in part, on any modifications needed to balance the RTP for the selected option calculated at 420 (i.e., to achieve approximately the same RTP, no matter which volatility pick option is selected by the player). For example, in some embodiments, the modification may comprise an extra free game mechanism utilizing a determined extra free game rate to award any additional free games to the player. For example, a base game may include a feature game trigger (e.g., based in part on a random event and a lookup table) that could incorporate the extra free game rate during the feature game. A lookup table could be employed to associate different numbers of extra free games with different weights and calculating the extra free game rate for a selected option could further include adjusting one or more of the different weights of the lookup table. In some embodiments, multiple lookup tables may be implemented.

As an example for illustration purposes, assume the base game determines that 18 free games are to be awarded to the player, and the player chooses the 4×5 grid size at the free game gateway. Using these inputs, the value of a weight W3 of a lookup table for extra free games is calculated. The calculation of the weight proceeds through multiple stages. First, the average total feature pay, including all retriggers, is calculated for the default grid size (e.g., 3×5 in this example).

An example formula for this calculation may be derived as follows:

TFP=EₙFG*W_{sd}

### Where:

TFP=total feature pay
EₙFG=the expected number of default grid size free games with retriggers
W_{sd}=win per spin for the default grid size

The total feature pay may represent the entirety of a payout for one cycle of a base game and any additional bonus features, sub-features, upgrades, etc. For example, in one cycle, a certain average number of free games/spins and/or retriggers within that cycle may be expected. This may be represented with EₙFG.

However, while EₙFG may represent the number of spins performed over the entirety of one game cycle, the expected amount awarded per spin needs to be known in order to calculate the total feature pay. The expected amount awarded per spin for the default grid size is represented here with W_{sd}. Thus, by multiplying the expected amount awarded per spin by the total expected number of spins in one game cycle, the average total feature pay (TFP) may be determined.

In determining the expected number of free games with retriggers (EₙFG) for the default grid size, several inputs may factor into this determination.

An example formula for EₙFG may be derived as follows:

EₙFG=FG_{id}/(1−(P_{xfgd}*E_{xfgd}+S_{fgd}))

### Where:

FG_{id}=the initial number of default grid size free games
P_{xfgd}=the probability to trigger extra free games via a wild win for the default grid size
E_{xfgd}=expected number of free games for the default grid size
S_{fgd}=expected number of free games from scatters for the default grid size

The expected number of free games with retriggers (EₙFG) for a default grid size may take into account, for example, the initial number of free games associated with the default grid size (FG_{id}), which may vary. The initial number of free games may be modified according to, for example, the number of free games expected from the default grid size (E_{xfgd}), the expected number of free games from scatters for the default grid size (S_{fgd}), and the probability to trigger extra free games via wild symbols (P_{xfgd}).

The target average number of extra free games (also referred to herein more generically as an example of a “target progressive feature prize value”) for the selected grid size can then be calculated. The formula for this calculation may be derived as follows:

T_{xfgs}=−1/(P_{xfgs})*(FGᵢₛ*Wₛₛ/TFP−1+S_{fgs})

### Where:

T_{xfgs}=target average number of free extra games for the selected grid size
P_{xfgs}=the probability to trigger extra free games via a wild win for the selected grid size
FGᵢₛ=the initial number of free games for the selected grid size
TFP=total feature pay
S_{fgs}=expected number of free games from scatters for the selected grid size
Wₛₛ=win per spin for the selected grid size

The initial number of free games for the selected grid size (FGᵢₛ) may be multiplied with the expected amount awarded per spin for the selected grid size (Wₛₛ) and further modified by the total feature payout (which is the same for the selected grid size as for the default grid size, for consistent RTP between different grid sizes) and the expected number of free games from scatters for the selected grid size. This may, in turn, be modified by the probability to trigger extra free games via wild wins for the selected grid size (P_{xfgs}). In this way, a target average number of free extra games for the selected grid size (T_{xfgs}) may be determined.

In this example, it is assumed the user selected the 4×5 grid size. The data for the variable FGᵢₛ can be found using the initial number of default grid size free games FG_{id} (here, 18) and the win factor shown in Table 1 (the xml table mapping) for the selected grid size. That is, FGᵢₛ=FG_{id}*factor. For example, for the 4×5 grid size:

FGᵢₛ=TRUNC(18/1.95)=9 free games

This illustrates that whenever a wild symbol substitutes in one or more wins for a grid of the selected grid size, an average adjustment of a certain number of extra free games (e.g., T_{xfgs}) may be needed to ensure the RTP is the same as for the default grid. With this average adjustment value, one or more weight values in the appropriate Extra Free Games_Feature_×weight table for the selected grid size (here, the “Extra_Free_Games_Feature_4×5” weight table) can be modified/adjusted to produce a proper payout.

As an example, a calculation for a new value for a weight W₃ associated with the entry for 3 extra free games in the weight table may be as follows:

W₃=TRUNC((T_{xfgs}*(W₀+W₁+W₂)−W₁−2*W₂)/(3−T_{xfgs}))

### Where;

W₀=weight value for 0 extra free games
W₁=weight value for 1 extra free game
W₂=weight value for 2 extra free games
T_{xfgs}=target average extra free games value for the selected grid size

In this equation, the factor of 2 is used because W₂ is associated with an entry for two extra free games, and the factor of 3 is used because W₃ is associated with an entry for three extra free games. In some embodiments, W₀>W₁>W₂>W₃. Using these relationships, appropriate values for the various weights may be determined, especially in an environment where RTP must be satisfied. For example, given values of weights for W₀, W₁, and W₂, a value for the weight W₃ can be calculated. Suppose the target average extra free games value for the 4×5 grid size is 1.84. If the values of W₀, W₁, and W₂ in the table Extra Free Games_Feature_3×5 (see above) are retained, a new value for the weight W₃ can be calculated as:

W₃=TRUNC((1.84*(350+40+20)−40−2*20)/(3−1.84))=581

To confirm, when the values of Wo, Wi, W2, and W3 are 350, 40, 20, and 581, respectively, the expected count of extra free games is (0*350+1*40+2*20+3*581)/991, which is 1.8396. In this way, by setting the value of W3 between 0 and an arbitrarily high value, the expected count of extra free games can be adjusted within the range of 0.2 to close to 3 (where 0.2 is the expected value when W₃ is 0). It is to be understood that, in other embodiments, it may also be possible to modify more than one weight to achieve the desired target average extra free games value (e.g., modifying the weight values for each of W₂ and W₃).

### III.F. Free Game Feature Alternative Embodiments

### a. Option 1

In an alternative embodiment, the game may randomly select an appropriate lookup table based on the target average number of extra free games, instead of solving W₃=TRUNC ((T_{xfg}*(W₀+W₁+W₂)−W₁−2*W₂)/(3−T_{xfg})). The lookup table may be associated with a specific range of extra free spins to add. In another embodiment, multiple weight tables may be used to implement the number of extra free spins to add (e.g., a first table where the expected value is A and a second table where the expected value is B, and then a coefficient is calculated to blend between the two tables and balance the number of extra free spins needed).

### b. Option 2

While embodiments of the present disclosure contemplate adjusting the added extra free spins via the free games feature, other game parameters may be modified to ensure each selectable grid size has the same RTP. For example, the extra free games lookup table may be the same for all grid sizes. However, to achieve the desired RTP, such a configuration may utilize multiple reel strip sets, each with a different average payout. In yet another embodiment, the game could employ dynamic symbols to vary the average payout, for example. In yet other embodiments, the game could employ mystery prizes, credits, line pays, etc. (i.e., rather than, or in addition to, determining an amount of extra free spins to award to the player) to achieve the desired RTP.

### III.G. Multi-Reel Sets Free Game Feature Implementation

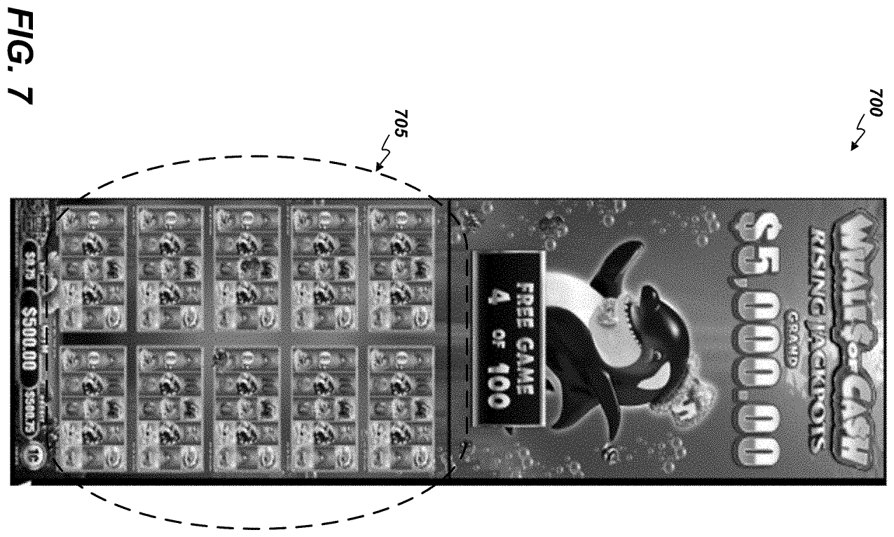

In some embodiments, e.g., wherein the number of free games awarded as part of a progressive feature prize, is large (e.g., greater than 100 games), such as is illustrated in screenshot 700 of FIG. 7, the number of free games may be played on multiple reel sets at a time to speed up gameplay and add visual excitement for the user (see 705 of FIG. 7). In FIG. 7, 10 reel sets are displayed when the grid size is 3×5. As another example, the number of reel sets may be based on the grid size selected as follows:

| Grid Size | Number of Reel Sets |
|---|---|
| 3x5 | 20 |
| 4x5 | 15 |
| 5x5 | 12 |
| 6x5 | 6 |
| 8x5 | 3 |

As an example implementation for this embodiment, assume 101 free games are awarded from the base game, and the user picks the 3×5 (default grid size) for the full 102 games. The game may transition to display ten 3×5 grids/reel sets in two columns of 10 each. Each spin may add 10 free games to an X of Y meter and spin all 20 reel sets. Any additional free games won may be added to the Y value of the meter. Assuming 2 extra fee games were won, Y=103. Once the number of free games remaining is less than 20 (the maximum number of displayable grids/reel sets), the remaining free games may be played out on a subset of the reel sets. In this particular example, once we have spun 5 sets of 20 grids/reel sets, one spin of 3 grids/reel sets will remain. The other grids may be grayed out, removed from the display, or otherwise inactivated during this last spin. As an additional example, if a user had selected a 5×5 grid size, the game would have transitioned to display 12 grids/reel sets.

### IV. Alternatives, Variations, and Conclusion

Numerous embodiments are described in this disclosure and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

For the sake of presentation, the detailed description uses terms like “determine” and “select” to describe computer operations in a computer system. These terms denote operations performed by a computer, and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to insure privacy and prevent fraud in any of a variety of ways well known in the art.

It will be readily apparent that the various methods and algorithms described herein may be implemented by, e.g., appropriately programmed general-purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A method for dynamically rebalancing progressive feature prizes, comprising:
determining a progressive feature prize value for a first option in an electronic game, the first option being one of multiple selectable options;
for a selected option of the multiple selectable options, determining an adjustment factor representing an adjustment as compared to the first option;
calculating, based, at least in part, on the adjustment factor and the progressive feature prize value determined for the first option, a progressive feature prize value for the selected option;
calculating at least one progressive feature prize value modification for the selected option, wherein the at least one progressive feature prize value modification is calculated to balance a return to player (RTP) between the selected option and the first option; and
modifying the calculated progressive feature prize value for the selected option, based, at least in part, on the at least one progressive feature prize value modification.

2. The method of claim 1, wherein the progressive feature prize value is variable, and wherein the progressive feature prize value is incremented based, at least in part, on a random event occurring in the electronic game.

3. The method of claim 1, wherein the progressive feature prize value comprises a determined number of free games for the first option.

4. The method of claim 3, wherein calculating the progressive feature prize value for the selected option comprises calculating a number of free games for the selected option, and wherein calculating a number of free games for the selected option comprises truncating a result of dividing the number of free games for the first option by the adjustment factor.

5. The method of claim 1, wherein the multiple selectable options are multiple grid sizes, different numbers of wild symbols added to reels, different multipliers, different approaches to resolving dynamic symbols in reels, or different numbers of wild reels.

6. The method of claim 1, wherein the adjustment factor is a win factor, the adjustment representing a difference in win rate for the selected option compared to the first option.

7. The method of claim 1, wherein determining the adjustment factor uses a lookup table, the lookup table associating different adjustment factors with different ones of the multiple selectable options.

8. The method of claim 1, wherein calculating the at least one progressive feature prize value modification comprises:
determining at least one modification to make to at least one weight in a lookup table associated with the selected option.

9. The method of claim 8, wherein making the determined at least one modification to the at least one weight in the lookup table associated with the selected option causes the RTP to be balanced between the selected option and the first option.

10. The method of claim 1, wherein the calculating at least one progressive feature prize value modification for the selected option comprises:
calculating, for the first option, an average feature pay;
calculating, based on an average feature pay for the first option and the adjustment factor for the selected option, a target progressive feature prize value for the selected option; and
calculating, based on the target progressive feature prize value for the selected option, at least one new value for a weight of a lookup table associated with the selected option.

11. One or more computer-readable media storing computer-executable instructions, which, when executed by a computer, cause the computer to perform the following operations:
determining a progressive feature prize value for a first option in an electronic game, the first option being one of multiple selectable options;
for a selected option of the multiple selectable options, determining an adjustment factor representing an adjustment as compared to the first option;
calculating, based, at least in part, on the adjustment factor and the progressive feature prize value determined for the first option, a progressive feature prize value for the selected option;
calculating at least one progressive feature prize value modification for the selected option, wherein the at least one progressive feature prize value modification is calculated to balance a return to player (RTP) between the selected option and the first option; and
modifying the calculated progressive feature prize value for the selected option, based, at least in part, on the at least one progressive feature prize value modification.

12. The one or more computer-readable media of claim 11, wherein the multiple selectable options are multiple grid sizes, different numbers of wild symbols added to reels, different multipliers, different approaches to resolving dynamic symbols in reels, or different numbers of wild reels.

13. The one or more computer-readable media of claim 11, wherein the adjustment factor is a win factor, the adjustment representing a difference in win rate for the selected option compared to the first option.

14. The one or more computer-readable media of claim 11, wherein determining the adjustment factor uses a lookup table, the lookup table associating different adjustment factors with different ones of the multiple selectable options.

15. The one or more computer-readable media of claim 11, wherein calculating the at least one progressive feature prize value modification comprises:
determining at least one modification to make to at least one weight in a lookup table associated with the selected option.

16. The one or more computer-readable media of claim 15, wherein making the determined at least one modification to the at least one weight in the lookup table associated with the selected option causes the RTP to be balanced between the selected option and the first option.

17. A system comprising:
a display;
one or more processors;
memory; and
control logic, implemented using the one or more processors and memory, configured to perform operations to control an electronic gaming device, the operations comprising:
determining a progressive feature prize value for a first option in an electronic game being displayed on the display of the electronic gaming device, the first option being one of multiple selectable options displayed as part of a volatility pick gateway being displayed on the display of the electronic gaming device;
for a selected option of the multiple selectable options, determining an adjustment factor representing an adjustment as compared to the first option;
calculating, based, at least in part, on the adjustment factor and the progressive feature prize value determined for the first option, a progressive feature prize value for the selected option;
calculating at least one progressive feature prize value modification for the selected option, wherein the at least one progressive feature prize value modification is calculated to balance a return to player (RTP) between the selected option and the first option;
modifying the calculated progressive feature prize value for the selected option, based, at least in part, on the at least one progressive feature prize value modification; and
displaying the progressive feature prize on the display of the electronic gaming device, according to the selected option and the modified calculated progressive feature prize value for the selected option.

18. The system of claim 17, wherein calculating the at least one progressive feature prize value modification comprises:
determining at least one modification to make to at least one weight in a lookup table associated with the selected option.

19. The system of claim 18, wherein making the determined at least one modification to the at least one weight in the lookup table associated with the selected option causes the RTP to be balanced between the selected option and the first option.

20. The system of claim 18, wherein the progressive feature prize value comprises a determined number of free games for the first option, and wherein calculating the progressive feature prize value for the selected option comprises calculating a number of free games for the selected option by truncating a result of dividing the number of free games for the first option by the adjustment factor.
